(19) United States
(12) Patent Application Publication
(10) Pub. No.: US 2022/0348309 A1
(43) Pub. Date: Nov. 3, 2022

(54) COMPACT FITTING FOR COUPLING BLADE TO ROTOR HUB

(71) Applicant: Bell Textron Inc., Fort Worth, TX (US)

(72) Inventors: George Matthew Thompson, Lewisville, TX (US); Jonathan Andrew Knoll, Burleson, TX (US); Nicholas Ralph Carlson, Dallas, TX (US); Joseph Richard Carpenter, JR., Burleson, TX (US)

(73) Assignee: Bell Textron Inc., Fort Worth, TX (US)

(21) Appl. No.: 17/246,705

(22) Filed: May 2, 2021

(51) Int. Cl. B64C 11/06; B64C 11/00; B64C 11/32; B64C 29/00

(52) U.S. Cl. CPC B64C 11/06; B64C 11/001; B64C 11/32; B64C 29/0033

(57) ABSTRACT

A fitting for securing a rotor blade in pivotable engagement with a yoke that is coupled to a mast of an aircraft for rotation therewith about a mast axis has a body that extends from an inboard end to an outboard end. The body of the fitting has an opening that extends into the body from the outboard end and that is adapted to receive a root end of the blade. The body further has a first bearing race that is defined along an outer surface of the body and is located between the inboard and outboard ends. The body further has an array of apertures that is located between the inboard end and the first bearing race, each aperture adapted to receive a respective fastener for retaining the blade within the opening.

### Background

Rotor aircraft have at least one rotor for providing lift and propulsion forces. Typically, such a rotor has a plurality of blades that are coupled to a yoke that is coupled to a mast of the aircraft for rotation therewith about a mast axis. The blades are pivotably coupled to the yoke such that each blade is pivotable about a respective pitch axis for adjusting the pitch of the blades. It is desirable to reduce the weight and manufacturing and/or maintenance complexity of rotor components and to provide rotor components in a compact size.

### BRIEF DESCRIPTION OF THE DRAWINGS

FIG. 1 is an oblique view of an aircraft with ducted rotors.

FIG. 2 is an oblique view of rotor components of the aircraft depicted in FIG. 1, including a rotor hub assembly, in accordance with this disclosure.

FIG. 3A is a side view of some of a portion of the rotor hub assembly depicted in FIG. 2, in accordance with this disclosure.

FIG. 3B is a cross-sectional view of the portion of the rotor hub assembly depicted in FIG. 3A, in accordance with this disclosure.

FIG. 4 is an oblique cross-sectional view of the portion of the rotor hub assembly depicted in FIG. 2, in accordance with this disclosure.

FIG. 5 is a cross-sectional view of an alternative embodiment of a portion of the rotor hub assembly depicted in FIG. 2, in accordance with this disclosure.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure describes a rotor blade having a built-up profile at its root end and a fitting for securing such a rotor blade in pivotable engagement with a rotor hub for use in aircraft such as, for example, a ducted-rotor aircraft.

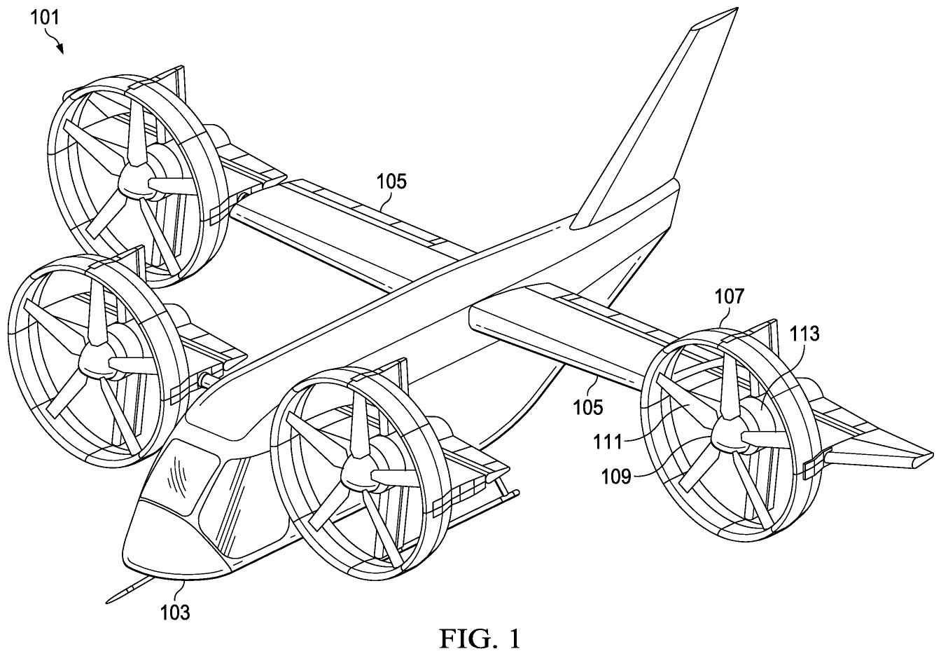

FIG. 1 is an oblique view of a ducted-rotor aircraft 101. Aircraft 101 comprises a fuselage 103 with a plurality of fixed wings 105 extending therefrom and a plurality of pivotable ducts 107. As shown, a duct 107 is located at an end of each wing 105. Each duct 107 houses a power plant for driving an attached rotor 109 in rotation. Each rotor 109 has a plurality of blades 111 configured to rotate within ducts 107. Each duct 107 includes a central hub 113 that is configured to receive a rotor 109 and/or other components.

The position of ducts 107, and optionally the pitch of blades 111, can be selectively controlled to control direction, thrust, and lift of rotors 109. For example, ducts 107 are repositionable to convert aircraft 101 between a helicopter mode and an airplane mode. As shown in FIG. 1, ducts 107 are positioned such that aircraft 101 is in airplane mode, which allows for high-speed forward-flight. Ducts 107 are repositionable to convert aircraft 101 into helicopter mode (not shown), which allows for vertical takeoff and landing, hovering, and low-speed directional movement.

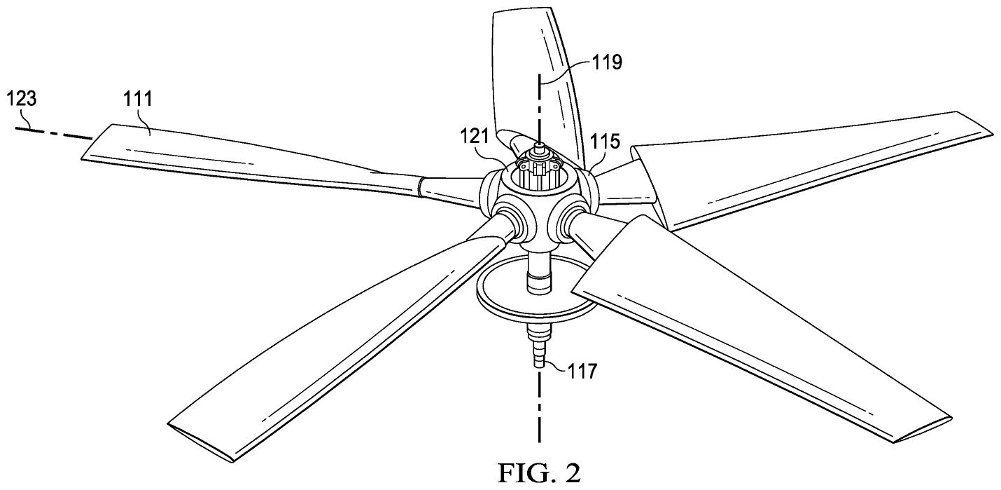

FIG. 2 is an oblique view of assembled components of a rotor 109 of aircraft 101. As shown, a rotor hub assembly 115 is coupled to a mast 117 for rotation therewith about a mast axis 119. Rotor hub assembly 115 includes five blades 111 and a yoke 121. Blades 111 are pivotably coupled to yoke 121 such that each blade is pivotable about a corresponding pitch axis 123.

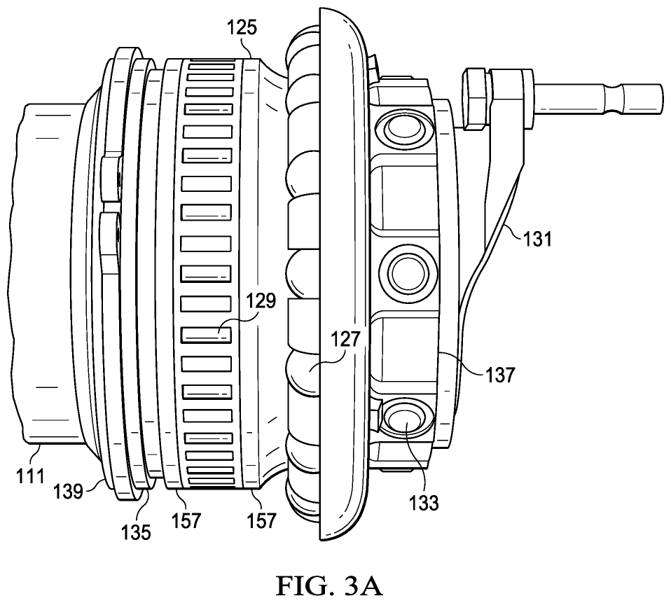

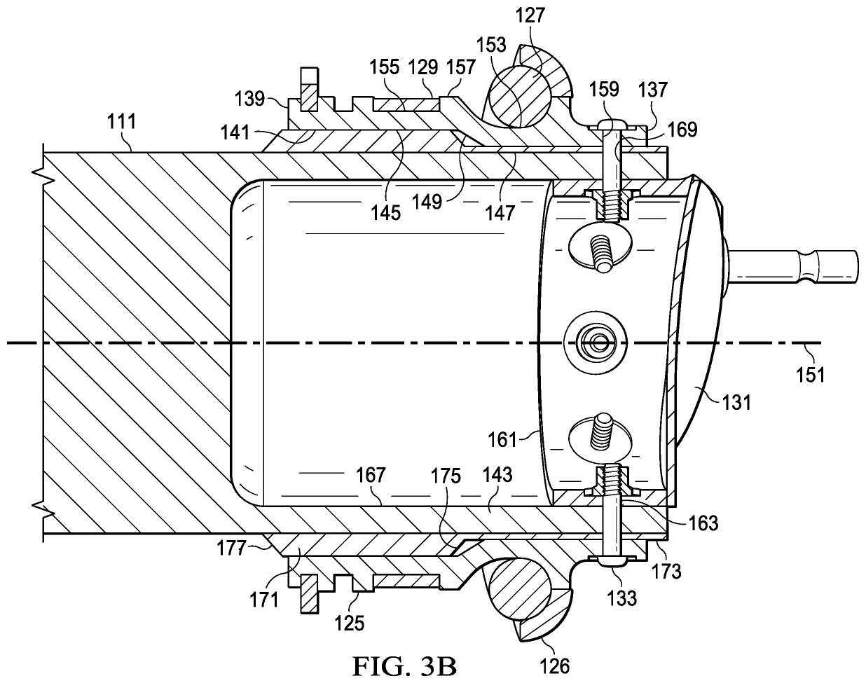

FIGS. 3A and 3B are side and cross-sectional views, respectively, of a portion of rotor hub assembly 115. The illustrated portion of rotor hub assembly 115 includes a blade 111, a fitting 125, a first plurality of bearings 127 supported by fitting 125, a second plurality of bearings 129 supported by fitting 125, a pitch horn 131, and a plurality of fasteners 133 that couple blade 111, fitting 125, and pitch horn 131 to one another. The plurality of fasteners 133 are sized to provide a load path that is capable of reacting centrifugal force from blade 111 to yoke 121.

Fitting 125 is a compact collar fitting for securing blade 111 in pivotable engagement with yoke 121. More specifically, fitting 125 is adapted to pivotably secure blade 111 within yoke 121 such that blade 111 is pivotable about pitch axis 123. In this embodiment, fitting 125 has a one-piece body 135 that extends from an inboard end 137 to an opposed outboard end 139. Inboard end 137 of body 135 corresponds to an inboard end of fitting 125 and outboard end 139 of body 135 corresponds to an outboard end of fitting 125. As shown, inboard end 137 is located closer to a corresponding mast axis 119 than outboard end 139 when fitting 125 is coupled within yoke 121 in an assembled configuration of rotor hub assembly 115, and more generally when fitting 125 is installed in aircraft 101. Preferably, body 135 of fitting 125 is made of metal, such as steel.

Fitting 125 has an opening 141 that extends into body 135 from outboard end 139. Opening 141 is adapted to receive a root end 143 of blade 111. In this embodiment, opening 141 extends through inboard end 137 of body 135. Stated differently, opening 141 extends all the way through body 135. In an alternative embodiment, fitting 125 can be differently adapted such that opening 141 extends partially into, rather than all the way through, body 135.

As shown, body 135 is configured such that opening 141 comprises a stepped opening having a first section 145, a second section 147, and a transition 149 between the first and second sections 145, 147. First section 145 extends inwardly from outboard end 139 of body 135, and second section 147 extends inwardly from inboard end 137 of body 135. Second section 147 is narrower than first section 145. Stated differently, second section 147 is stepped inward toward a central axis 151 of fitting 125, relative to first section 145. In this embodiment, first and second sections 145, 147 are cylindrical, and central axis 151 is coincident with pitch axis 123. Body 135 is further configured such that a transition 149 is defined where first section 145 meets second section 147. In this embodiment, transition 149 has a frustoconical geometry.

Body 135 of fitting 125 includes a first bearing race 153 that is adapted to carry the first plurality of bearings 127 and a second bearing race 155 that is adapted to carry the second plurality of bearings 129. As shown, first bearing race 153 is located between the inboard and outboard ends 137, 139 of body 135 and is defined by an arc-shaped channel that extends into an outer surface 157 of body 135. The second bearing race 155 is located between first bearing race 153 and outboard end 139 of body 135 and is defined by a recess that extends into outer surface 157.

In this embodiment, the first plurality of bearings 127 are implemented as ball bearings that ride in the channel of first bearing race 153. Rotor hub assembly 115 can further include one or more components adapted to retain first plurality of bearings 127 within first bearing race 153. As shown, rotor hub assembly 115 further includes a first retention ring 126 and a second retention ring 128 that are adapted to retain first plurality of bearings 127 within first bearing race 153. Each of first retention ring 126 and second retention ring 128 can be provided in one or more pieces. In this embodiment, first retention ring 126 is provided in four pieces and is adapted to space the bearings of first plurality of bearings 127 within first bearing race 153. Second retention ring 128 is provided as a single piece that is adapted to be press fit into yoke 121, and that is adapted to react forces in cooperation with first plurality of bearings 127. In operation, first plurality of ball bearings 127 roll along the continuous inner surface of second retention ring 128 as fitting 125 pivots about pitch axis 123. Preferably, one or both of first and second retention rings 126, 128 are adapted to be couplable to fitting 125. The second plurality of ball bearings 129 are implemented as needle roller bearings that ride in the recess of second bearing race 155.

The first plurality of ball bearings 127, in cooperation with fitting 125 and second retention ring 128, provide a load path for reacting centrifugal force from blade 111 to yoke 121. The second plurality of ball bearings 129 provides a load path for reacting out-of-plane and in-plane moments from fitting 125 to yoke 121. Out-of-plane moments include those created by blades 111 rotating outside a blade plane of rotation of rotor 109, for example. In operation, when blades 111 rotate with mast 117, first and second pluralities of bearings 127, 129 and second retention ring 128 cooperate to react forces and moments while ensuring that blades 111 remain pivotable about their respective pitch axes 123.

Body 135 of fitting 125 further includes an array of apertures 159 that is located between inboard end 137 and first bearing race 153. Each aperture 159 is adapted to receive a respective one of plurality of fasteners 133 for retaining blade 111 within opening 141. In this embodiment, each aperture 159 extends through body 135 along a direction that is perpendicular to central axis 151 of fitting 125, and apertures 159 are equally spaced radially about central axis 151.

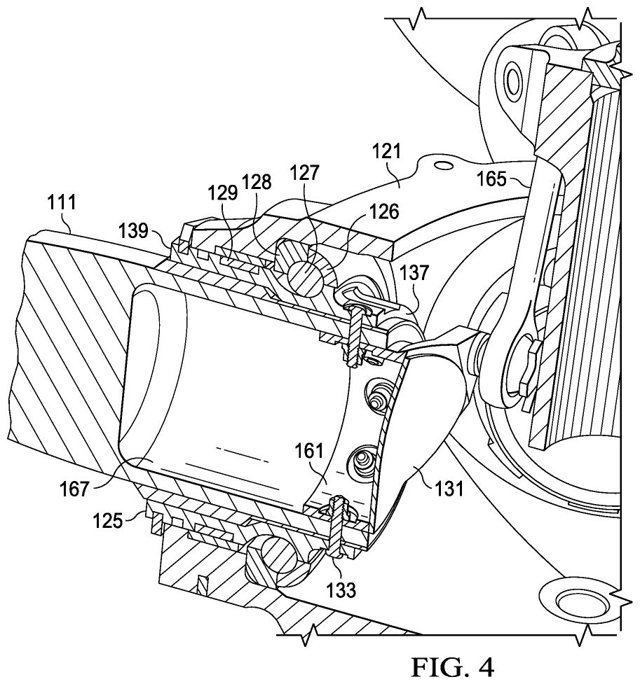

Pitch horn 131 is coupled to fitting 125, and blade 111, via the plurality of fasteners 133. In this embodiment, pitch horn 131 has a cylindrical insert 161 that is adapted to be received in opening 141 at inboard end 137 of body 135, along with root end 143 of blade 111, and coupled to fitting 125 via plurality of fasteners 133. Insert 161 has an array of apertures 163 that extend therethrough along a direction that is perpendicular to central axis 151 of fitting 125. Each aperture 163 is adapted to receive a respective one of plurality of fasteners 133 and to align with a respective aperture 159 of fitting 125. Preferably, pitch horn 131 is adapted to be coupled to one or more other components of aircraft 101 to enable rotation of blade 111 about pitch axis 123, such as linkage 165 for example, as seen in FIG. 4.

In this embodiment, blades 111 are constructed of composite material. In this disclosure, composite material preferably refers to plies of a fiber-reinforced plastic (FRP) composition that includes filament fibers, such as carbon fibers for example, embedded in a thermoset polymer matrix material such as a thermoplastic resin. Preferably the fibers within the plies are woven and the plies are pre-impregnated with resin. To illustrate, blades 111 may be constructed from one or more layered plies of carbon-fiber-reinforced plastic (CFRP). It should be appreciated that blades 111 are not limited to being made of CFRP, and that blades 111 may be constructed of any other suitable material.

Blade 111 has an opening 167 that extends inward into blade 111 at root end 143. Insert 161 of pitch horn 131 is adapted to be received in opening 167. Root end 143 further has an array of apertures 169 that extend therethrough along a direction that is perpendicular to pitch axis 123. Each aperture 169 is adapted to receive a respective one of plurality of fasteners 133 and to align with a respective aperture 159 of fitting 125 and aperture 163 of pitch horn 131.

As shown, root end 143 of blade 111 has a cylindrical geometry and is adapted to be received in opening 141 of fitting 125. More specifically, root end 143 has an outboard section 171, an inboard section 173, and a transition 175 between the outboard and inboard sections, 171, 173. Inboard section 173 is narrower than outboard section 171. Stated differently, inboard section 173 is stepped inward toward pitch axis 123, relative to outboard section 171. Outboard section 171 is adapted to abut fitting 125 within first section 145 of opening 141 and inboard section 173 is adapted to abut fitting 125 within second section 147. In this embodiment, transition 175 has a frustoconical geometry that does not conform to the geometry of transition 149 of opening 141. Preferably, outboard section 171 includes a ramped portion 177 that extends beyond outboard end 139 of fitting 125 to gradually transition stiffness and reduce stress concentration.

The stepped geometries of opening 141 and root end 143 provide weight savings, for example compared to a configuration in which opening 141 and root end 143 are non-stepped; in effect exchanging metal material of fitting 125 for lighter composite material of outboard section 171 of root end 143. Additionally, the stepped geometries of opening 141 and root end 143 of blade 111 can provide for easier installation of blades 111 during assembly of rotor hub assembly 115, for example compared to a fitting and blade having a single-level close tolerance fit relative to each other. The stepped geometries described herein can help mitigate undesirable effects of single-level pipe fit tolerances, such as bind-up. To illustrate, when inserting root end 143 of blade 111 into opening 141, inboard section 173 fits easily within first section 145 of opening 141 and can contact and slide along transition 149, which can assist with aligning inboard section 173 for insertion into second section 147 of opening 141.

One or both of root end 143 of blade 111 and opening 141 of fitting 125 can be adapted to define respective bonding surfaces for adhesively securing blade 111 within opening 141 and reacting centrifugal force from blade 111 to yoke 121. For example, one or both of first and second sections 145, 147 of opening 141 and one or both of outboard and inboard sections 171, 173 of root end 143 can be adapted to define respective bonding surfaces for adhesively bonding root end 143 within opening 141.

In this embodiment, first section 145 of opening 141 and outboard section 171 of root end 143 are adapted to be adhesively bonded to one another with a first bondline of adhesive, and second section 147 of opening 141 and inboard section 173 of root end 143 are adapted to be adhesively bonded to one another with a second bondline of adhesive. The first and second bondlines of adhesive are preferably adapted to cooperatively provide a load path that is equally capable of reacting centrifugal force from blade 111 to yoke 121 as are fasteners 133.

In a preferred method of manufacturing blade 111, outboard section 171 and inboard section 173 are formed by building up layers of composite material on root end 143, for example using one or more layers of fiberglass, and co-curing the fiberglass and CFRP materials. Alternatively, outboard and inboard sections 171, 173 can be formed in a separate process, for example built up and cured on root end 143 after blade 111 has been cured. After curing, one or both of outboard section 171 and inboard section 173 can be machined to ensure proper tolerances for root end 143 of blade 111 being received in opening 141 of fitting 125. Alternatively still, outboard section 171 and inboard section 173 can be formed and pre-bonded within opening 141, and outboard and inboard sections 171, 173 can then be co-cured with blade 111.

It should be appreciated that fitting 125 is not limited to the geometry of opening 141 illustrated and described herein. For example, opening 141 of fitting 125 can be alternatively adapted with one or more additional stepped sections, with one or more of the stepped sections having non-cylindrical geometry, for example tapered, and so on in any suitable combination. It should further be appreciated that root end 143 of blade 111 is similarly not limited to the geometry illustrated and described herein, and that root end 143 of blade 111 can be alternatively adapted to be received in an alternatively adapted opening 141. It should further still be appreciated that fitting 125, blade 111, and pitch horn 131 are not limited to the corresponding arrays of apertures illustrated and described herein, and that one or more of those components can be alternatively adapted with more or fewer apertures having equal or unequal spacing relative to each other.

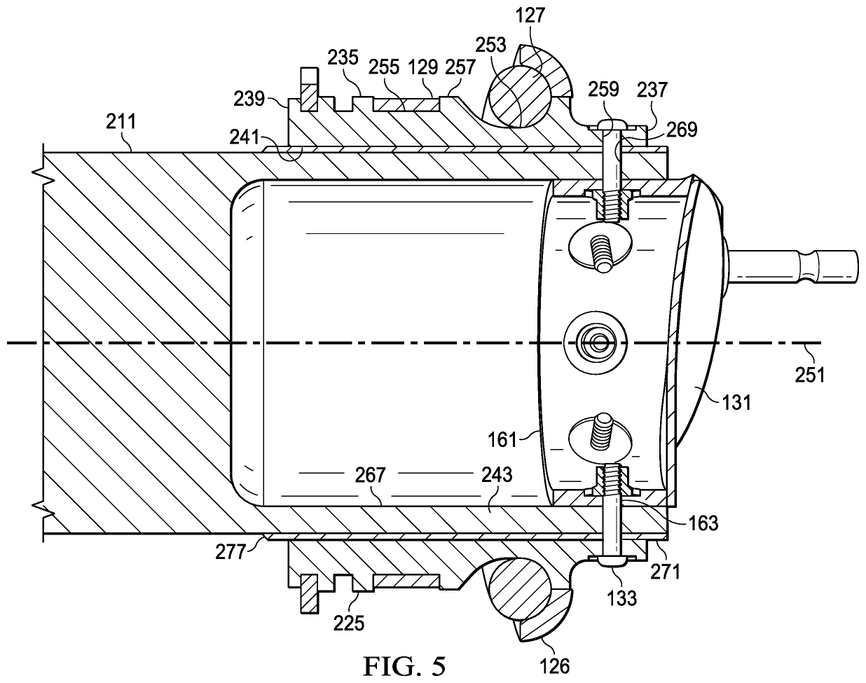

FIG. 5 is a cross-sectional view of a portion of an alternative embodiment of rotor hub assembly 115 that includes alternative blade 211 in place of blade 111 and alternative fitting 225 in place of fitting 125. For the sake of clarity and conciseness, elements and features of fitting 225 and blade 211 that correspond, at least partially, to those of fitting 125 and blade 111, respectively, are labeled with reference numbers incremented by 100 relative to those of fitting 125 and blade 111.

Fitting 225 is a compact collar fitting for securing blade 211 in pivotable engagement with yoke 121. More specifically, fitting 225 is adapted to pivotably secure blade 211 within yoke 121 such that blade 211 is pivotable about pitch axis 123. In this embodiment, fitting 225 has a one-piece body 235 that extends from an inboard end 237 to an opposed outboard end 239. Inboard end 237 of body 235 corresponds to an inboard end of fitting 225 and outboard end 239 of body 235 corresponds to an outboard end of fitting 225. As shown, inboard end 237 is located closer to mast axis 119 than outboard end 239 when fitting 225 is coupled within yoke 121, and more generally when fitting 225 is installed in aircraft 101. Preferably, body 235 of fitting 225 is made of metal, such as steel.

Fitting 225 has an opening 241 that extends into body 235 from outboard end 239. Opening 241 is adapted to receive a root end 243 of blade 211. In this embodiment, opening 241 extends through inboard end 237 of body 235. Stated differently, opening 241 extends all the way through body 235. In an alternative embodiment, fitting 225 can be differently adapted such that opening 241 extends partially into, rather than all the way through, body 235. As shown, body 235 is configured such that opening 241 is cylindrical about a central axis 251 of fitting 225.

Body 235 of fitting 225 includes a first bearing race 253 that is adapted to carry the first plurality of bearings 127 and a second bearing race 255 that is adapted to carry the second plurality of bearings 129. As shown, first bearing race 253 is located between the inboard and outboard ends 237, 239 of body 235 and is defined by an arc-shaped channel that extends into an outer surface 257 of body 235. The second bearing race 255 is located between first bearing race 253 and outboard end 239 of body 235 and is defined by a recess that extends into outer surface 257.

In this embodiment, the first plurality of bearings 127 are implemented as ball bearings that ride in the channel of first bearing race 253 and rotor hub assembly 115 further includes first retention ring 126 and second retention ring 128 that are adapted to retain first plurality of bearings 127 within first bearing race 253. Each of first retention ring 126 and second retention ring 128 can be provided in one or more pieces. In this embodiment, first retention ring 126 is provided in four pieces and is adapted to space the bearings of first plurality of bearings 127 within first bearing race 253. Second retention ring 128 is provided as a single piece that is adapted to be press fit into yoke 121, and that is adapted to react forces in cooperation with first plurality of bearings 127. In operation, first plurality of ball bearings 127 roll along the continuous inner surface of second retention ring 128 as fitting 225 pivots about pitch axis 123. Preferably, one or both of first and second retention rings 126, 128 are adapted to be couplable to fitting 225. The second plurality of ball bearings 129 are implemented as needle roller bearings that ride in the recess of second bearing race 255.

The first plurality of ball bearings 127, in cooperation with fitting 225 and second retention ring 128, provide a load path for reacting centrifugal force from blade 211 to yoke 121. The second plurality of ball bearings 129 provides a load path for reacting out-of-plane and in-plane moments from fitting 225 to yoke 121. Out-of-plane moments include those created by blades 211 rotating outside a blade plane of rotation of rotor 109, for example. In operation, when blades 211 rotate with mast 117, first and second pluralities of bearings 127, 129 and second retention ring 128 cooperate to react forces and moments while ensuring that blades 211 remain pivotable about their respective pitch axes 123.

Body 235 of fitting 125 further includes an array of apertures 259 that is located between inboard end 237 and first bearing race 253. Each aperture 259 is adapted to receive a respective one of plurality of fasteners 133 for retaining blade 211 within opening 241. In this embodiment, each aperture 259 extends through body 235 along a direction that is perpendicular to central axis 251 of fitting 225, and apertures 259 are equally spaced radially about central axis 251. Each aperture 259 aligns with a corresponding aperture 163 of pitch horn 131, such that fitting 225, pitch horn 131, and blade 211 are adapted to be coupled to one another via the plurality of fasteners 133.

In this embodiment, blades 211 are constructed of composite material. To illustrate, blades 211, like blades 111, may be constructed from one or more layered plies of carbon-fiber-reinforced plastic (CFRP). It should be appreciated that blades 211 are not limited to being made of CFRP, and that blades 211 may be constructed of any other suitable material.

Blade 211 has an opening 267 that extends inward into blade 211 at root end 243. Opening 267 is adapted to receive insert 161 of pitch horn 131. Root end 243 further has an array of apertures 269 that extend therethrough along a direction that is perpendicular to pitch axis 123. Each aperture 269 is adapted to receive a respective one of plurality of fasteners 133 and to align with a respective aperture 259 of fitting 225 and aperture 163 of pitch horn 131.

As shown, root end 243 of blade 211 has a cylindrical geometry and is adapted to be received in opening 241 of fitting 225. More specifically, root end 243 has a section 271 that is adapted to abut fitting 225 within opening 241. Preferably, section 271 includes a ramped portion 277 that extends beyond outboard end 239 of fitting 225 to gradually transition stiffness and reduce stress concentration.

One or both of root end 243 of blade 211 and opening 241 of fitting 225 can be adapted to define respective bonding surfaces for adhesively securing blade 211 within opening 241 and reacting centrifugal force from blade 211 to yoke 121. In this embodiment, opening 241 and section 271 of root 243 are adapted to be adhesively bonded to one another with a bondline of adhesive. The bondline of adhesive is adapted to provide a load path that is equally capable of reacting centrifugal force from blade 211 to yoke 121 as are fasteners 133.

In a preferred method of manufacturing blade 211, section 271 is formed by building up layers of composite material on root end 243, for example using one or more layers of fiberglass, and co-curing the fiberglass and CFRP materials. Alternatively, section 271 can be formed in a separate process, for example built up and cured on root end 243 after blade 211 has been cured. After curing, section 271 can be machined to ensure proper tolerances for root end 243 of blade 211 being received in opening 241 of fitting 225. Alternatively still, section 271 can be formed and pre-bonded within opening 241, and sections 271 can then be co-cured with blade 211.

It should be appreciated that fitting 225 is not limited to the geometry of opening 241 illustrated and described herein. For example, opening 241 of fitting 225 can be alternatively adapted with a non-cylindrical geometry, for example tapered. It should further be appreciated that root end 243 of blade 211 is similarly not limited to the geometry illustrated and described herein, and that root end 243 of blade 211 can be alternatively adapted to be received in an alternatively adapted opening 241. It should further still be appreciated that fitting 225, blade 211, and pitch horn 131 are not limited to the corresponding arrays of apertures illustrated and described herein, and that one or more of those components can be alternatively adapted with more or fewer apertures having equal or unequal spacing relative to each other.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

1. A fitting for pivotably coupling a rotor blade to a yoke for rotation about a pitch axis, the yoke being coupled to a mast of an aircraft for rotation therewith about a mast axis, the fitting comprising:
a body that extends from an inboard end to an outboard end, the body having:
an opening that extends into the body from the outboard end and that is adapted to receive a root end of the blade;
a first bearing race that is defined along an outer surface of the body and is located between the inboard and outboard ends; and
a circumferential array of apertures, each aperture adapted to receive a respective fastener for retaining the blade within the opening, each aperture also adapted to orient the respective fastener as perpendicular to the pitch axis.

2. The fitting of claim 1, wherein the opening is a stepped opening having a first section and a second section that is narrower than the first section.

3. The fitting of claim 2, wherein the first and second sections are cylindrical.

4. The fitting of claim 3, wherein the opening includes a transition from the first section to the second section.

5. The fitting of claim 4, wherein the transition is frustoconical.

6. The fitting of claim 2, wherein at least one of the first and second sections of the opening is adapted to be bonded adhesively to the blade.

7. The fitting of claim 1, wherein the array of apertures is located between the inboard end and the first bearing race.

8. The fitting of claim 1, the body further having a second bearing race that is defined along the outer surface of the body and is located between the first bearing race and the outboard end.

9. The fitting of claim 1, wherein the opening extends through the inboard end of the body.

10. A rotor hub assembly adapted to be coupled to a mast of an aircraft for rotation therewith about a mast axis, the rotor hub assembly comprising:
a rotor blade;
a yoke that is adapted to be coupled to the mast;
a fitting that is adapted to pivotably secure the blade within the yoke such that the blade is pivotable about a pitch axis;
a first plurality of bearings that reacts centrifugal force from the blade to the yoke;
a plurality of fasteners in a circumferential array that secure a root end of the blade to the fitting at a location inboard of the first plurality of bearings, each fastener being oriented as perpendicular to the pitch axis; and
a second plurality of bearings that reacts out-of-plane and in-plane moments from the fitting to the yoke.

11. The rotor hub assembly of claim 10, further comprising:
a pitch horn that is coupled to the fitting via the plurality of fasteners.

12. The rotor hub assembly of claim 11, wherein the fitting comprises a body that extends from an inboard end to an outboard end, the inboard end located closer to the mast axis than the outboard end, the body having:
an opening that extends into the body from the outboard end and that is adapted to receive a root end of the blade;
a first bearing race that is adapted to receive the first plurality of bearings and that is located between the inboard and outboard ends; and
an array of apertures that is located between the inboard end and the first bearing race, each aperture adapted to receive a corresponding one of the plurality of fasteners.

13. The rotor hub assembly of claim 12, wherein the opening is a stepped opening having a first section and a second section that is narrower than the first section.

14. The rotor hub assembly of claim 13, wherein at least one of the first and second sections of the opening is adapted to be bonded adhesively to the blade.

15. The rotor hub assembly of claim 13, wherein the root end of the rotor blade has an outboard section that is adapted to abut the fitting within the first section of the opening and an inboard section and that is adapted to abut the fitting within the second section of the opening.

16. The rotor hub assembly of claim 13, wherein the first and second sections are cylindrical.

17. The rotor hub assembly of claim 16, wherein the opening further comprises a frustoconical transition from the first section to the second section.

18. The rotor hub assembly of claim 10, wherein the opening extends through the inboard end of the body.

19. The rotor hub assembly of claim 18, further comprising:
a pitch horn that is adapted to be received in the opening at the inboard end of the body and coupled to the fitting via the plurality of fasteners.

20. The rotor hub assembly of claim 12, the body further having a second bearing race that is adapted to receive the second plurality of bearings and is located between the first bearing race and the outboard end.
